(19) United States
(12) Patent Application Publication
(10) Pub. No.: US 2023/0273303 A1
(43) Pub. Date: Aug. 31, 2023

(54) TEST STAND FOR STIMULATING A PHOTODETECTOR

(71) Applicant: dSPACE GmbH, Paderborn (DE)

(72) Inventors: Jan TLATLIK, Bielefeld (DE); Gregor SIEVERS, Paderborn (DE)

(73) Assignee: dSPACE GmbH, Paderborn (DE)

(21) Appl. No.: 18/143,856

(22) Filed: May 5, 2023

Related U.S. Application Data
(63) Continuation of application No. PCT/EP2021/075857, filed on Sep. 21, 2021.

(30) Foreign Application Priority Data
Nov. 6, 2020 (DE) 10 2020 129 241.4

(51) Int. Cl. G01S 7/497; G01S 7/481

(52) U.S. Cl. CPC G01S 7/497; G01S 7/4811

(57) ABSTRACT

A test bench for stimulating a photodetector, with a light signal device, which includes a planar arrangement of lighting elements that are able to be activated and deactivated independently of each other and which is designed to emit light emitted by any lighting element in an at least approximately collimated light beam, with a converging lens, which is designed and positioned to focus light beams emitted by the light signal device at an accumulation point, and with a retaining device for a photodetector arranged at the accumulation point, by means of which retaining device a photodetector can be placed at the accumulation point in such a way that a first light beam produced by any first light source and a second light beam produced by any second light source hit the photodetector at different spatial angles with respect to an optical axis of the test bench.

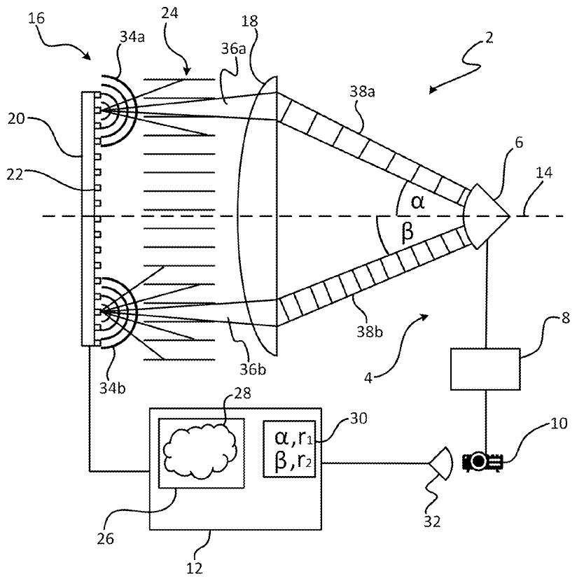

This nonprovisional application is a continuation of International Application No PCT/EP2021/075857, which was filed on Sep. 21, 2021, and which claims priority to German Patent Application No 10 2020 129 241.4, which was filed in Germany on Nov. 6, 2020, and which are both herein incorporated by reference.

### BACKGROUND OF THE INVENTION

### Field of the Invention

Environmental sensor systems are sensor systems designed to evaluate sound waves or electromagnetic waves emanating from objects in order to detect objects. Active environmental sensor systems are set up to radiate a signal into their environment and evaluate reflections of the signal, for example, to locate an object based on the direction and round-trip time of a reflection or to measure the velocity of an object based on the frequency shift of a reflection. Otherwise, one speaks of passive environmental sensor systems. According to the current state of the art, active environmental sensor systems are normally based on ultrasound, radio waves (radar) or short-wave light (lidar). Examples of passive systems are image-evaluating camera systems, motion sensors and passive radar.

### Description of the Background Art

Environmental sensor systems are used in safety-critical systems, for example to control robots or automated vehicles, and then require a particularly thorough evaluation before they are used in series production in order to rule out malfunctions as far as possible. For this purpose, target simulators exist on the market. These are test benches which are configured to register a signal emitted by an active environmental sensor system for detecting objects and to produce a time-delayed echo signal in order to simulate a reflection of the signal on an object for the environmental sensor system.

An example of a radar target simulator is dSPACE GmbH's radar test bench. This comprises a number of antennas arranged on rotating rings, by means of which radar echoes arriving from different directions can be simulated for a radar system arranged as a device under test (product information “Radar Test bench”, available at https://www.dspace.com/shared/data/pdf/2020/dSPACE-Radar-Testbench_Product-Information_2020-03_E.pdf)).

Meanwhile, concepts for lidar target simulators for lidar systems are also known. An exemplary description can be found in the article “LIDAR echo emulator” by Pawel Adamiec et al. (International Conference on Space Optics—ICSO 2018). The target simulator described therein comprises two laser diodes for simulating two reflections of a lidar signal, each of which is transmitted to the device under test via an optical fiber. For certain test cases, however, such a setup is too simple. An example is a lidar system designed to control an autonomous or highly automated vehicle. Such a lidar system is set up for the simultaneous localization of a large number of objects in the vehicle environment. Accordingly, a target simulator suitable for testing such a lidar system should be multi-target enabled, i.e., it should be designed to produce a plurality of simulated reflections, which can hit a photodetector of an environmental sensor system arranged as a device under test from a sufficiently large spectrum of different spatial directions.

### SUMMARY OF THE INVENTION

It is therefore an object of the invention to provide a test bench for light-based environmental sensor system(s). The environmental sensor system has an operating principle that is based on a detection of an electromagnetic wave emanating from an object, in particular from the visible, ultraviolet or infrared spectrum, via a photodetector.

Thus, in an exemplary embodiment, the test bench comprises a light signal device, which comprises a planar arrangement of lighting elements that are able to be activated and deactivated independently of each other and which is designed to emit, in an at least approximately collimated, i.e., parallel-aligned, light beam, light emitted by any lighting element.

In other words, it is essential for a test bench according to the invention that each lighting element is able to be controlled individually and independently of other lighting elements on the light signal device in order to emit light, and that the light signal device is designed to emit, in the form of an at least approximately collimated light beam, light emitted by any lighting element, so that an activation of a certain number of lighting elements causes the same number of at least approximately collimated light beams to be emitted from the light signal device, wherein each light beam is emitted from exactly one activated lighting element.

The test bench also includes a converging lens, which is designed and positioned to focus light beams emitted by the light signal device at an accumulation point. If the light signal device is designed to emit the light beams parallel to each other and with respect to the optical axis of the converging lens, the accumulation point is equal to a focal point of the converging lens.

A retaining device for a photodetector is located at the accumulation point, by means of which retaining device a photodetector can be placed at the accumulation point in such a way that a first light beam produced by means of any first lighting element and a second light beam produced by any second lighting element hit the photodetector at different spatial angles with respect to an optical axis of the test bench.

The test bench according to the invention is multi-target enabled. Depending on the resolution of the light signal device, basically any number of light beams can be produced simultaneously in order to simulate any number of targets in different spatial directions for the photodetector or for an environmental sensor system comprising the photodetector. At the same time, the test bench is relatively inexpensive and low maintenance because it can be operated with a planar light signal device and has no moving parts. To simulate a number of targets by means of the test bench, it is provided to specify a number of spatial angles from a spectrum of spatial angles, which covers in its entirety a field of view of the photodetector, wherein each of the predetermined spatial angles corresponds to a direction of a simulated virtual (i.e., not real) object in the field of view of the photodetector. By means of the light signal device, a number of suitable light beams, corresponding to the number of spatial angles, is then emitted, which are focused by the lens at the accumulation point in such a way that each light beam hits the photodetector located at the accumulation point at exactly one spatial angle from the number of spatial angles with respect to the optical axis of the test bench.

Different examples are possible for the light signal device. The light signal device does not necessarily have to be designed as a uniform component but may also comprise several spatially separated components.

The light signal device can comprise a planar arrangement of point light sources, for example photodiodes, which can be activated and deactivated independently. In general, a point light source is to be understood as a light source which, freely arranged in space, does not produce a collimated light beam, but produces a substantially spherical electromagnetic wavefront. To produce the at least approximately collimated light beams, the light signal device also comprises a transparent collimator surface positioned between the planar arrangement and the converging lens, which is designed to absorb or reflect light incident on the collimator surface at a sufficiently acute angle.

Such collimator surfaces are available on the market, for example as “Light-Control-Film” (LC film) or “collimator film” at Falcon Illumination MV GmbH & Co. KG. The effect of the collimator surface is that it transmits only those parts of the light emitted by each lighting element that are aligned at least approximately parallel with respect to the optical axis of the test bench, so that each lighting element produces an at least approximately collimated light beam aligned parallel with respect to the optical axis behind the collimator surface.

The planar arrangement of point light sources may be designed as a planar arrangement of discrete and self-luminous light sources, for example as a planar arrangement of photodiodes. In an alternative embodiment, the planar arrangement comprises a backlight and a screen arranged between the backlight and the collimator surface, which is divided into a plurality of controllable cells, each of which can be set to a transparent or non-transparent state by controlling the respective cell, so that in combination with the backlight, each transparent cell acts as a point light source. For example, the screen may be a liquid crystal screen, though it should be noted that the response time of a liquid crystal screen may be too slow for certain applications of the test bench.

Also, the collimator surface can be dispensable. For this purpose, the light signal device may be designed as a planar arrangement of collimated light sources, each of which emits an at least approximately collimated light beam when activating the respective light source. For this purpose, the collimator surface may be designed, for example, as a planar arrangement of semiconductor lasers or as a planar arrangement of lighting elements, each of which is provided with a collimator lens or a concave mirror.

The production of well-collimated light beams is technically complex. In particular, collimator surfaces are normally only able to roughly collimate incident light. In most, especially the particularly cost-effective, versions of the test bench, an emission of only approximately collimated, cone-shaped light beams from the light signal device is to be expected. In an advantageous embodiment, the focal length of the converging lens is chosen such that it compensates for the cone shape of the light beams, i.e., converts the cone-shaped light beams in their refraction into at least approximately plane electromagnetic waves, which from the perspective point of view of the photodetector then represent themselves approximately as infinitely distant points of light. The converging lens can also be selected with regard to its focal length in such a way that it slightly bundles or fans out the cone-shaped light beams, i.e., converts them into cone-shaped light beams that slightly reduce or increase their cone circumference on their way from the lens to the photodetector. From the perspective point of view of the photodetector, this leads to a certain blurring of the perceived points of light, which can certainly be a desirable technical effect. The blurring can cause adjacent light points to merge seamlessly, which can be advantageous for credible modeling of patterns such as vehicle outlines, for an automotive lidar system, or for generally large light points for simulating large objects.

Preferably, the test bench can comprise a programmable control device which is configured to control the light signal device to activate selected lighting elements on the light signal device according to the specifications of a control program programmed on the control device to produce a light pattern on the light signal device. The light pattern may include a number of isolated activated lighting elements, or it may include clusters of adjacent activated lighting elements to simulate large points of light or extended objects for the photodetector. The light pattern can be static or dynamic, i.e., temporally changeable. The control program can read out information defining the design of the light pattern from a data memory integrated into the test bench, in particular the control device. The control device may include an interface for providing the information by an instance located outside the test bench. The control device may comprise an interface for depositing the information in the data memory by an instance located outside the test bench. In particular, this instance may be a simulation computer that processes a simulation within which a virtual instance of the photodetector interacts with virtual objects in a virtual environment, wherein the control device is configured to read in relative positions of virtual objects provided by the simulation computer and to control the light signal device such that the light beams emitted by the light signal device for the photodetector simulate light emitted by the virtual objects.

Advantageously, the control program can comprise a simulation of the refractive behavior of the converging lens in order to take into account the refractive behavior when producing the light pattern. In particular, the control program may be designed to take into account lens errors and perspective distortions when producing the light pattern.

The test bench may be designed as a target simulator for an active environmental sensor system, in particular a lidar system. In this embodiment, the test bench comprises a detector for detecting a light signal from an environmental sensor system arranged as a device under test in the test bench, and the control program is designed to determine round-trip times and spatial directions of reflections of the light signal on virtual objects and, by controlling the light signal device, to produce a light pattern for simulating the reflections according to the specification of the determined spatial directions and round-trip times for a photodetector of the environmental sensor system arranged in the retaining device.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The invention is explained in more detail below on the basis of the drawing. The drawing and its description disclose an exemplary embodiment of an inventive test bench designed as a target simulator and a beam path of the test bench. The drawing is schematized and does not allow conclusions to be drawn about the geometric dimensions and distances between the components shown.

### DETAILED DESCRIPTION

The illustration of the drawing shows a lidar system 4 arranged as a device under test in a test bench 2, comprising a laser device 10 for illuminating the environment of the lidar system 4 by means of a light signal in the form of a laser pulse located in the infrared light spectrum, a photodetector 6 arranged in a retaining device of the test bench 2 for detecting reflections of the laser pulse on objects in the environment of the lidar system 4, and a control unit 8 for controlling the laser device 10 and for evaluating the reflections detected by means of the photodetector 6. The evaluation may include, in particular, the detection of spatial angles and round-trip times of the reflections in order to locate objects in the environment on the basis of the reflections. The evaluation may also include image recognition to assign labels to localized objects and mark them in this way, for example, as vehicles, pedestrians, traffic signs, trees or buildings. Furthermore, the evaluation may include velocity measurement of objects by repeated localization of the objects.

The test bench 2 comprises a control device 12, and, lined up along an optical axis 14 of the test bench 2, a light signal device 16, a plano-convex converging lens 18 and a retaining device (not shown) for the photodetector 6. The light signal device 16 comprises a planar arrangement as lighting elements designed as infrared photodiodes 22, arranged on a carrier board 20, and a transparent collimator surface 24. The carrier board 20 comprises an interface by means of which each photodiode 22 can be individually, i.e., independently of the other photodiodes, activated and deactivated, i.e., switched on and off.

The control device 12 is connected by means of a data line to the interface of the carrier board 20 to produce a light pattern on the light signal device 16 by activating or deactivating selected photodiodes 22. For this purpose, the control device 12 comprises a processor 26 on which a control program 28 is programmed, and a data memory 30 on which relative positions of virtual objects can be deposited. By way of example, two positions of virtual objects are stored in the data memory 30. Each position stored in the data memory 30 is stored as a spherical coordinate, i.e., it comprises a spatial angle α, β and a distance r₁, r₂.

The control device 12 comprises an interface (not shown) for depositing positions in the data memory 30. The depositing of positions can be arbitrarily complex. In the simplest case, the positions are deposited statically. The positions can be overwritten by new items in a predefined order. The positions can be incrementally changed in small increments to simulate objects in motion. The depositing of the positions can be carried out in particular by a simulation computer which processes a simulation in which a virtual instance of the photodetector 6 interacts in a virtual environment with other virtual objects, wherein the positions deposited by the simulation computer in the data memory 30 represent relative positions of virtual objects to the photodetector 6 in a field of view of the virtual instance of the photodetector 6. Of course, it is also possible to represent a single virtual object through a variety of positions to simulate an extended object or complex geometry of an object through a plurality of spatial points.

The control device 12 also comprises a detector 32 for detecting a light signal from the laser device 10. By way of example, the detector 32 is designed as a photodetector, but other embodiments are also possible. For example, the detector 32 may be configured to detect a control signal transmitted from the control device 8 to the laser device 10 to trigger a light signal.

The control program 28 is configured to detect a light signal of the laser device 10 by means of the detector 32. As soon as the control program 28 detects a light signal, it retrieves the positions stored in the data memory 30. Based on the distances r₁, r₂, the control program 28 calculates a round-trip time of the light signal for each position, and based on the spatial angles α, β, the control program determines a photodiode 22 to be activated to simulate a reflection of the light signal. By way of example, two positions of two point-shaped virtual objects are stored, a first object at the position (α, r₁) and a second object at the position (β, r₂). The first round-trip time t₁ of the reflection of the light signal on the first object is calculated by the control program 28 using the formula:

t₁=2cr₁

(c: speed of light). To determine the photodiode 22 to be activated to simulate the reflection, the control program 28 comprises a simulation of the refractive behavior of the converging lens 18, on the basis of which the control program 28 performs a calculation of the beam path shown in the FIGURE in the opposite direction of the light. The control program thus assumes a light beam that is emitted by the photodetector 6 at a spatial angle α with respect to the optical axis 14 and simulates the path of this light beam through the converging lens 18 to calculate a first starting point of the light beam on the carrier board 20. In an analogous manner, the control program 28 calculates a second round-trip time t₂ and a second starting point for the second object.

To simulate a reflection of the light signal on the first object, the control device 12 activates the photodiode 22 closest to the first starting point or a cluster of photodiodes 22 arranged around the first starting point. To simulate a reflection of the light signal on the second object, the control device 12 activates the photodiode 22 closest to the second starting point or a cluster of photodiodes 22 arranged around the second starting point.

In the FIGURE, two photodiodes 22 are activated according to the two reflections to be simulated. Each of the activated photodiodes 22 produces an electromagnetic elementary wave 34a, 34b propagating in all free spatial directions. The collimator surface 24 is an arrangement of light channels which absorbs from each elementary wave 34a, 34b all portions that hit the collimator surface 24 at a sufficiently acute angle, so that behind the collimator surface 24 a cone-shaped first light beam 36a, starting from the first starting point, and a cone-shaped second light beam 36b, starting from the second starting point, arise.

For the invention it is essential that at least approximately collimated light beams 36a, 36b emanate from the light signal device 16, but the collimation does not necessarily have to take place on a collimator surface 24. Alternatively, the light signal device 16 may be designed as a planar arrangement of collimated light sources, each of which individual light source is designed to directly emit an at least approximately collimated light beam. For this purpose, the lighting elements 22 may be designed, for example, as a semiconductor laser or as light sources, each of which is provided with a collimator lens or a concave mirror.

The focal length of the converging lens 18 is chosen such that it converts the cone-shaped light beams 36a, 36b into at least approximately plane electromagnetic waves 38a, 38b, in other words, it improves the collimation of the light beams. A first plane wave 38a emerging from the first light beam 36a hits, according to the known law of reversibility of light beams, at spatial angle α with respect to the optical axis 14 on the photodetector 6, and a second plane wave 38b emerging from the second light beam 36b hits the photodetector 6 in an analogous manner at spatial angle β with respect to the optical axis 14. The photodetector is thus arranged at an accumulation point at which the first plane wave 38a and the second plane wave 38b meet and which in the case shown coincides with a focal point of the converging lens 18.

Assuming that the plane waves 38a, 38b are perfectly collimated, i.e., represent ideal plane waves, the photodetector 6 perceives them as point-like virtual images that are arranged at an infinite distance in its field of vision at the spatial angles α and β. Under real conditions, no converging lens 18 can be constructed that converts any light beam 36a, 36b into an ideal plane wave. If the plane waves 38a, 38b are at least slightly fanned out or focused, the photodetector 6 perceives them, assuming that the photodetector 6 is focused to infinity, as fuzzy points. As shown above, this may well be advantageous because it allows for the simulation of extended objects by activating a plurality of adjacent photodiodes 22, which the photodetector 6 then perceives as uniformly and continuously illuminated objects. Of course, the focal length of the converging lens 18 may also be deliberately chosen such that it produces slightly focused or fanned out plane waves 38a, 38b.

The times of the activations of the two photodiodes are each selected such that the time elapsed between the emission of the light signal by the laser device 10 and the arrival of a plane wave 38a, 38b at the photodiode 6 corresponds to the round-trip time that the control device 12 has calculated for the reflection simulated by the respective plane wave 38a, 38b. Specifically, the control device 12 controls the light signal device 16 such that the first plane wave 38a arrives exactly after expiry of the time span t₁ after emission of the light signal at the photodiode 6 and the second plane wave 38b arrives exactly after expiry of the time span t₂ at the photodiode 6. For this purpose, the simulation of the refractive behavior of the converging lens 18 implemented in the control program 28 also includes a consideration of the propagation times of the light beams 36a, 36b from the carrier board 20 to the photodiode 6 and a consideration of the signal propagation time from the detector 32 to the control device 12, the signal propagation time from the control device 12 to the light signal device 16 and the response times of the photodiodes 22.

In the test case shown in the FIGURE and described above, the focus is on a test of the control unit 8. The control unit 8 can thus be safely testable in a largely virtual environment in a reproducible manner, even in extreme situations that cannot be safely reproduced in a field test or on a test site. Of course, the test bench 2 can also be used for other test purposes. For example, only the photodetector 6, without control unit 8 and laser device 10, may be arranged as a device under test, and the control device 12 is programmed to sequentially activate all lighting elements 22 to verify a correct function of the photodetector 6. Likewise, the test bench 6 can be used for an end-of-line test of the photodetector 6 or the entire lidar system 4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A test bench for stimulating a photodetector, the test bench comprising:
a light signal device that comprises a planar arrangement of lighting elements that are adapted to be activated and deactivated independently of each other and that is designed to emit, in an at least approximately collimated light beam, light emitted by at least one of the lighting elements;
a converging lens positioned to focus light beams emitted by the light signal device at an accumulation point; and
a retaining device for a photodetector, the retaining device being arranged at the accumulation point, via which retaining device a photodetector is adapted to be placed at the accumulation point such that a first light beam produced by any first lighting element and a second light beam produced by any second lighting element hit the photodetector at different spatial angles with respect to an optical axis of the test bench.

2. The test bench according to claim 1, wherein the light signal device comprises a planar arrangement of point light sources, which are activated and deactivated independently, and wherein the light signal device comprises a transparent collimator surface arranged between the planar arrangement and the converging lens, which is designed to absorb or reflect light incident on the collimator surface at a sufficiently acute angle.

3. The test bench according to claim 2, wherein the planar arrangement of point light sources is designed as a planar arrangement of discrete and self-luminous light sources, in particular photodiodes.

4. The test bench according to claim 2, wherein the planar arrangement of point light sources includes a backlight and a screen arranged between the backlight and the collimator surface, which is divided into a plurality of controllable cells, each of which are adapted to be set into a transparent or non-transparent state by controlling the respective cell.

5. The test bench according to claim 1, wherein the light signal device is designed as a planar arrangement of collimated light sources or semiconductor lasers, wherein the lighting elements are provided with collimator lenses or the lighting elements are provided with concave mirrors, each of which, upon activation of the respective light source, directly emits an at least approximately collimated light beam.

6. The test bench according to claim 1, wherein the light signal device is designed to emit light emitted by any lighting element in an only approximately collimated cone-shaped light beam, and wherein the converging lens is designed with regard to its focal length to convert the cone-shaped light beams in their refraction into at least approximately plane waves.

7. The test bench according to claim 1, further comprising a programmable control device configured to control the light signal device in order to activate or deactivate selected lighting elements on the light signal device according to the specifications of a control program programmed on the control device, in order to produce a static or dynamic light pattern on the light signal device.

8. The test bench according to claim 7, wherein the control program comprises a simulation of the refractive behavior of the converging lens in order to take the refractive behavior into account when generating the light pattern.

9. The test bench according to claim 7, wherein the test bench is adapted for target simulation for an active environmental sensor system or a lidar system comprising a detector for detecting the emission of a light signal by the environmental sensor system, and wherein the control program determines round-trip times and spatial angles of reflections of the light signal on virtual objects and controls the light signal device to produce a light pattern for simulating the reflections according to a specification of determined spatial angles and round-trip times for a photodetector of the environmental sensor system arranged in the retaining device.

10. A method for stimulating a photodetector of an environmental sensor system for testing the environmental sensor system, the method comprising:
arranging a light signal device, which comprises a planar arrangement of lighting elements that activate and deactivate independently of each other and which is designed to emit light emitted by any lighting element in an at least approximately collimated light beam, and a converging lens, such that the converging lens focuses light beams emitted by the light signal device at an accumulation point;
arranging the photodetector at the accumulation point;
specifying a number of spatial angles from a spectrum of spatial angles covering in its entirety a field of view of the photodetector, wherein each spatial angle from the number of spatial angles corresponds to a direction of a simulated virtual object in the field of view of the photodetector; and
emitting at least two light beams corresponding to the number of spatial angles via the light signal device, the at least two light beams being focused by the converging lens at the accumulation point in such a way that each light beam hits on the photodetector at exactly one spatial angle from the number of spatial angles with respect to an optical axis.
